(19) United States
(12) Patent Application Publication
(10) Pub. No.: US 2026/0252903 A1
(43) Pub. Date: Aug. 27, 2026

(54) META-LEARNING NEURAL NETWORK FOR ADAPTIVE PATTERN DETECTION

(71) Applicants: Shubham Chandra, Katy, TX (US); Ravi Kiran Bhaskar, CentReville, VA (US); Sharad Baranwal, Oak Hill, VA (US)

(72) Inventors: Shubham Chandra, Katy, TX (US); Ravi Kiran Bhaskar, CentReville, VA (US); Sharad Baranwal, Oak Hill, VA (US)

(21) Appl. No.: 19/060,681

(22) Filed: Feb. 22, 2025

(51) Int. Cl. G06N 3/0985; G06N 3/042; G06N 3/049

(52) U.S. Cl. CPC G06N 3/0985; G06N 3/042; G06N 3/049

(57) ABSTRACT

This invention presents a hybrid approach integrating Model-Agnostic Meta-Learning (MAML) with Neural Networks for adaptive and real-time anomaly detection across various domains, including healthcare, cybersecurity, industrial monitoring, and predictive analytics. The Neural Network component captures temporal dynamics and relational structures within high-dimensional data, such as medical imaging scans, network traffic logs, sensor data, and financial transactions, enabling the identification of complex, evolving anomalies. MAML enhances the model's adaptability, allowing it to rapidly generalize to new abnormal patterns with minimal labeled data. This is particularly valuable in detecting rare diseases in medical diagnostics, zero-day cyber threats, equipment failures in industrial systems, and financial fraud in transactional data. The combination of graph-based learning, temporal sequence modeling, and meta-learning ensures high detection accuracy, scalability, and real-time responsiveness, making it a versatile and robust solution for dynamic and complex environments where traditional models struggle to generalize.

### BACKGROUND

### Technical Field

The present invention pertains to adaptive Pattern detection across multiple domains, including cybersecurity, healthcare, finance, and industrial systems. It introduces a novel framework that integrates Neural Networks with adaptive meta-learning algorithms to deliver a highly efficient, scalable, and generalized Pattern detection system.

This invention leverages temporal and relational data analysis to detect, classify, and adapt to evolving anomalies in real time, ensuring robust performance in dynamic and complex environments. By combining graph-based learning with meta-learning, the system generalizes across diverse data distributions, making it suitable for applications such as fraud detection, medical diagnostics, network security, and predictive maintenance. This invention was developed independently, without any federally or government-sponsored research or development funding.

### TECHNICAL BACKGROUND OF THE INVENTION

Pattern detection plays a crucial role in ensuring the integrity, reliability, and security of various domains, including healthcare, finance, industrial systems, cybersecurity, and smart infrastructure. In an increasingly complex and data-driven world, identifying deviations from normal patterns is essential for fraud detection, predictive maintenance, medical diagnostics, network security, and operational resilience. The expansion of artificial intelligence (AI), Internet of Things (IoT), cloud computing, and automation has significantly increased the volume and complexity of data, necessitating advanced Pattern detection techniques that can adapt to evolving patterns in real time.

Across different sectors, challenges such as data noise, high-dimensional relationships, concept drift, false positives, and adversarial manipulation hinder effective Pattern detection. In healthcare, detecting early signs of diseases, organ failures, or neurological disorders requires sophisticated models that can analyze time-series medical data, MRI scans, and EEG patterns. In finance, identifying fraudulent transactions, insider trading, or credit risks demands adaptive learning mechanisms that can continuously refine decision boundaries. Industrial systems, including manufacturing and energy grids, require predictive analytics to monitor equipment failures, sensor anomalies, and supply chain inefficiencies. Similarly, network security faces increasingly complex attack patterns, with zero-day exploits, insider threats, and advanced persistent threats (APTs) bypassing traditional defense mechanisms.

The evolving nature of threats and abnormalities across industries underscores the need for scalable, adaptive, and explainable AI-driven detection systems. Traditional rule-based or statistical models struggle to keep pace with real-time complexities and often fail to generalize across different data sources and domains. Machine learning (ML) and deep learning (DL) techniques, particularly those leveraging graph-based learning and meta-learning, offer a promising solution by capturing hidden patterns, structural dependencies, and temporal relationships across heterogeneous datasets.

To address these challenges, an adaptive Pattern detection system can integrate Temporal Graph Neural Networks (TGNNs) and meta-learning algorithms, enabling dynamic learning and adaptation across multiple application areas. Graph Neural Networks (GNNs) offer a unique advantage in modeling structured relationships within data, allowing for the identification of critical anomalies in cybersecurity attack graphs, financial transaction networks, biomedical imaging, and industrial sensor networks. Graph Convolutional Networks (GCNs) facilitate semi-supervised learning, while Graph Attention Networks (GATs) refine predictions by focusing on high-impact connections within noisy or dynamic environments. Temporal Graph Neural Networks (TGNNs) further enhance detection capabilities by incorporating time-evolving data patterns, making them ideal for real-time Pattern detection in continuously changing systems.

By leveraging automation, neural networks, and adaptive intelligence, this framework enables efficient Pattern detection across diverse industries, reducing reliance on manual intervention while improving response times and predictive accuracy. Organizations can integrate real-time monitoring, intelligent decision support, and cross-domain Pattern detection, ensuring robust protection against evolving threats in sectors ranging from finance and healthcare to industrial automation and cybersecurity. Furthermore, incorporating blockchain-based audit trails, explainable AI (XAI), and federated learning approaches ensures trust, security, and compliance while reducing operational risks associated with anomalous behavior.

This invention represents a scalable, intelligent, and domain-agnostic solution for adaptive Pattern detection, with applications spanning fraud prevention, predictive maintenance, medical diagnostics, operational efficiency, and risk management. By harnessing temporal and relational data analysis, graph-based learning, and meta-learning, the system provides an advanced, self-evolving approach to detecting, classifying, and mitigating anomalies across multiple disciplines, addressing critical challenges in an ever-changing technological landscape.

Each type of neural network plays a unique role in advancing AI capabilities. The choice of network depends on the nature of the data and the specific requirements of the application, with ongoing innovations continually expanding their potential.

TABLE 1
Comparison of Graph Neural Network (GNN) Techniques

| Technique | Key Feature | Advantages | Limitations | Applications |
|---|---|---|---|---|
| Graph | Generalizes | Effective for | Limited | Intrusion |
| Convolutional | convolutional | semi-supervised | scalability, | detection, |
| Networks | operations to | learning and | graph size- | recommendation |
| (GCNs) | graphs | static graphs | sensitive | systems |
| Graph | Utilizes | Handles noisy/ | Higher | Social networks, |
| Attention | attention | heterogeneous | computational | drug interaction |
| Networks | mechanisms | graphs, flexible | cost | prediction |
| (GATs) | for edge | | | |
| | importance | | | |
| Graph | Distinguishes | Strong | High | Molecular |
| Isomorphism | graph | structural | computational | property |
| Networks | structures | representation | complexity | prediction, |
| (GINs) | using injective | | | chemical |
| | functions | | | synthesis |
| GraphSAGE | Inductive | Scalable, | Potential loss of | Link prediction, |
| (Sample and | approach, | generalizes | information due | large-scale |
| Aggregate) | sampling | to unseen | to sampling | graphs |
| | neighbors for | nodes | | |
| | aggregation | | | |
| Spectral | Uses graph | Mathematically | Computationally | Physics |
| GNNs | Laplacian | rigorous | intensive, not | simulations, |
| | eigenvalues | | scalable | small graph |
| | for spectral | | | analysis |
| | analysis | | | |
| Spatial GNNs | Focuses on | Efficient | Requires explicit | Traffic |
| | spatial | for dynamic | spatial | forecasting, |
| | relationships | graphs | configuration | spatiotemporal |
| | rather than | | | analysis |
| | adjacency | | | |
| | matrices | | | |
| Dynamic | Incorporates | Captures | High model | Time-series |
| GNNs | temporal | evolving | complexity | prediction, |
| | changes in | patterns | | evolving |
| | graphs | effectively | | networks |
| Temporal | Combines | Models | Computationally | Cybersecurity, |
| Graph Neural | temporal | relational | intensive for | real-time |
| Networks | dynamics with | and temporal | long time spans | monitoring, |
| (TGNNs) | GNN features | information | | dynamic graphs |

Meta-learning, or “learning to learn,” is an advanced machine learning paradigm that enables models to rapidly adapt to new tasks with minimal data. By leveraging prior knowledge from related tasks, meta-learning facilitates efficient generalization, making it highly effective in dynamic, data-scarce, and rapidly evolving environments. This capability is particularly valuable in Pattern detection across various domains, including healthcare, cybersecurity, finance, industrial monitoring, and smart infrastructure, where anomalies often present as rare and evolving patterns.

Several meta-learning techniques have been developed, each addressing different challenges and offering unique advantages in adapting to unseen patterns, enhancing decision-making, and improving prediction accuracy.
Model-Agnostic Meta-Learning (MAML) is a gradient-based approach that trains models to quickly adapt to new tasks with minimal fine-tuning. By optimizing a shared initialization across multiple tasks, MAML allows fast adaptation to novel conditions through a few gradient updates. This technique is highly versatile, making it suitable for applications such as early disease detection, fraud analysis, and predictive maintenance. However, its computational intensity due to second-order derivative calculations may limit scalability.
Prototypical Networks classify new data by mapping it to a low-dimensional embedding space, where class prototypes serve as reference points. This approach is computationally efficient, particularly for few-shot learning tasks, such as diagnosing rare diseases, identifying financial fraud, or detecting emerging cyber threats. However, its effectiveness depends on well-separated data distributions, making it less robust in noisy or overlapping datasets.
Relation Networks excel in one-shot and verification tasks by calculating similarity scores between pairs of data points. This approach is well-suited for Pattern verification applications, such as biometric authentication, transaction validation, and network security event correlation. However, the computational cost increases significantly when applied to large datasets, as it requires evaluating all possible data pairs.
Memory-Augmented Neural Networks (MANNs) incorporate external memory storage, allowing models to retain and retrieve historical patterns. This method is particularly useful for tasks requiring temporal dependencies, such as chronic disease monitoring, financial trend forecasting, or cyberattack pattern analysis. However, managing and accessing large memory modules efficiently remains a challenge in large-scale applications.
Gradient-Based Meta-Learning improves upon MAML by reducing computational complexity, making it a more resource-efficient solution for adaptive Pattern detection in real-time environments. While it offers fast adaptation, it may struggle with highly non-linear or complex task distributions, such as medical diagnostics with highly variable patient data or fraud detection with evolving transaction patterns.
Learning to Optimize (L2O) shifts from traditional gradient-based learning to adaptive optimization, where meta-models learn to optimize themselves for different problem types. This approach can accelerate convergence and improve efficiency in Pattern detection tasks, including real-time predictive maintenance, industrial fault detection, and financial fraud prevention. However, its reliance on extensive training may hinder its ability to generalize completely new tasks.

Each of these meta-learning approaches has distinct strengths and limitations, making them suitable for different applications. For instance, MAML's adaptability is ideal for few-shot learning and reinforcement learning, while prototypical networks excel in classification tasks like medical imaging or network intrusion detection. Relation networks are well-suited for pattern verification, whereas MANNs shine in sequential and temporal Pattern analysis. Gradient-based meta-learning and L2O offer promising solutions for zero-shot learning and optimization challenges, respectively.

The choice of meta-learning strategy depends on the specific domain requirements, data availability, and computational constraints. By leveraging the strengths of graph-based learning, temporal data analysis, and adaptive meta-learning, AI systems can be more efficient, robust, and generalizable, addressing complex Pattern detection challenges across a wide range of industries, from cybersecurity and finance to healthcare and industrial automation.

Table 2 presents a comparative analysis of various meta-learning techniques, highlighting their key strengths, limitations, and applicability across different domains. This comparison provides insights into how each method performs in adaptive learning scenarios, aiding in the selection of the most suitable approach for dynamic and data-scarce environments.

TABLE 2
Comparison of Meta-Learning Techniques

| Technique | Key Feature | Advantages | Limitations | Applications |
|---|---|---|---|---|
| MAML | Gradient-based | Rapid task | Computationally | Few-shot learning, |
| | meta-learning | adaptation, | expensive | reinforcement |
| | | versatile | | learning |
| Prototypical | Embedding- | Simple, | Assumes well- | Image classification, |
| Networks | based | efficient for | separated data | medical diagnostics |
| | classification | few-shot | | |
| | | learning | | |
| Relation | Relational | Effective for | Computationally | Object recognition, |
| Networks | reasoning | one-shot | expensive for large | verification tasks |
| | between data | learning | datasets | |
| | pairs | | | |
| MANNs | External | Captures | High complexity in | Sequential tasks, |
| | memory for | temporal | memory | language modeling |
| | storing task | dependencies | management | |
| | info | | | |
| Gradient- | Task-specific | Simplified | May struggle with | Zero-shot learning, |
| Based Meta- | gradient | computation | complex tasks | personalized |
| Learning | updates | compared to | | recommendations |
| | | MAML | | |
| Learning to | Training meta- | Faster | Poor generalization | Optimization |
| Optimize | optimization | convergence on | to novel tasks | problems, |
| (L20) | algorithms | specific tasks | | hyperparameter |
| | | | | tuning |

Existing Pattern detection systems primarily rely on rule-based methods, static machine learning models, or manually defined heuristics, which limit their ability to adapt to evolving threats or anomalies in dynamic environments. These conventional approaches struggle with high false positive rates, inability to detect novel attacks, and inefficiencies in processing complex temporal and relational data. In contrast, the present invention introduces a hybrid neural network model that integrates Temporal Graph Neural Networks (TGNN) with meta-learning algorithms, offering real-time adaptation, improved Pattern classification, and enhanced generalization to unseen data distributions.

Unlike traditional static methods, this invention leverages temporal dependencies and relational data from multi-modal inputs-such as network traffic logs, system events, and user activity patterns—to improve detection accuracy. TGNNs model dynamic changes in data structures over time, while the meta-learning component allows rapid adaptation with minimal labeled data, making the system particularly effective for zero-day attacks, polymorphic malware, and novel fraud patterns. This hybrid approach ensures superior performance in intrusion detection, medical Pattern classification, financial fraud detection, and industrial monitoring, making it significantly more scalable and robust than prior solutions.

TABLE 3
Comparison of the Present Invention Against Prior Art

| | Traditional | Machine Learning- | Present Invention (TGNN + |
|---|---|---|---|
| Feature | Methods | Based Methods | Meta-Learning) |
| Adaptability | Static, rule- | Limited adaptation | Dynamic, real-time adaptation |
| | based | | to new anomalies |
| Handling Novel | Poor (requires | Moderate (requires | Strong (meta-learning enables |
| Threats | manual updates) | retraining) | rapid adaptation to zero-day |
| | | | attacks) |
| Temporal | Not supported | Basic time-series | Advanced temporal learning via |
| Analysis | | models | TGNN |
| Relational Data | Not supported | Limited graph-based | Fully integrated with graph |
| Utilization | | models | structures for complex |
| | | | dependencies |
| Scalability & | Manual tuning | Computationally | Optimized for real-time |
| Efficiency | required | expensive | performance with minimal |
| | | | labeled data |
| False Positive | High (due to | Moderate | Lower false positives with |
| Rate | rigid rules) | | contextual learning |
| Few-Shot | Not supported | Requires large | Highly efficient learning with |
| Learning | | datasets | minimal data |
| Capability | | | |
| Applicability | Narrow, | Limited cross-domain | Broad applicability |
| Across Domains | domain-specific | generalization | (cybersecurity, healthcare, |
| | | | finance, industrial automation, |
| | | | etc.) |

### SUMMARY OF THE INVENTION

The present invention introduces a hybrid neural network model that combines Temporal Graph Neural Networks (TGNNs) with meta-learning algorithms to enable adaptive and real-time Pattern detection across diverse domains, including cybersecurity, healthcare, finance, and industrial systems. TGNNs enhance the system's ability to analyze temporal dynamics and structural relationships within complex datasets, while meta-learning allows for rapid adaptation to new anomalies or evolving threats with minimal labeled data.

Unlike conventional methods that rely on static rules, predefined thresholds, or retraining on large datasets, this invention dynamically adapts to emerging patterns, making it highly effective for detecting zero-day attacks, rare medical conditions, financial fraud, and operational anomalies. By leveraging multi-modal data inputs such as network traffic logs, medical imaging scans, financial transactions, or industrial sensor data, the system achieves superior accuracy and reliability in detecting both known and unknown abnormalities.

The meta-learning framework ensures that the model can update its parameters quickly, reducing dependency on extensive retraining and improving performance in data-scarce environments. Meanwhile, TGNNs provide deeper insights into time-sensitive, interconnected relationships, enabling context-aware Pattern classification in rapidly changing environments.

By integrating TGNNs and meta-learning, this invention offers a highly adaptive, scalable, and efficient solution for real-time Pattern detection. It represents a significant advancement in AI-driven Pattern classification, addressing the challenges of evolving attack vectors, high-dimensional data, and the increasing complexity of modern threat landscapes across multiple industries.

### DETAILED DESCRIPTION OF THE INVENTION

The present invention introduces a hybrid neural network model that integrates Temporal Graph Neural Networks (TGNNs) with meta-learning algorithms to achieve adaptive and real-time Pattern detection across various domains, including cybersecurity, healthcare, finance, and industrial monitoring. Traditional Pattern detection methods rely on static rule-based models or predefined thresholds, making them ineffective against dynamic, evolving, and previously unseen anomalies. These conventional approaches require large labeled datasets and frequent retraining, limiting their scalability and responsiveness in real-world applications.

In contrast, this invention leverages TGNNs to capture temporal and relational dependencies within structured data, enabling context-aware Pattern classification. The meta-learning component further enhances adaptability, allowing the system to generalize across different environments with minimal data. By dynamically learning from multi-modal inputs-such as network traffic logs, medical imaging scans, financial transactions, and industrial sensor data—this system significantly outperforms traditional models in terms of detection accuracy, efficiency, and adaptability.

One of the key components of this invention is Temporal Graph Neural Networks (TGNNs), which extend traditional Graph Neural Networks (GNNs) by incorporating time-sensitive dependencies. Unlike conventional graph-based models that only analyze static relationships, TGNNs dynamically model evolving interactions, making them particularly effective for real-time monitoring of anomalies in fields such as cybersecurity (tracking network intrusions), healthcare (analyzing brain activity over time), and financial fraud detection (identifying suspicious transaction patterns).

TGNNs process data as a graph, where nodes represent entities (e.g., MRI slices, network packets, or financial transactions) and edges capture temporal or relational dependencies. This structure allows the model to learn from previous anomalies and anticipate future deviations. Unlike traditional machine learning approaches, which often struggle with context-awareness, TGNNs enable the system to differentiate between normal fluctuations and truly anomalous events, significantly reducing false positives.

A key innovation of this invention is the integration of Model-Agnostic Meta-Learning (MAML), a powerful gradient-based meta-learning technique that optimizes the model for rapid adaptation to new Pattern patterns with minimal retraining. Unlike conventional deep learning models that require large-scale labeled datasets, MAML ensures that the system can efficiently converge to a new task-specific solution using only a few examples, making it particularly effective in data-scarce environments such as rare disease diagnosis, emerging financial fraud patterns, and novel cybersecurity threats. The meta-learning objective is defined as:

$${θ}^{*} = θ - α {∇}_{θ} \sum {ℒ}_{{task}_{i}} ( θ - β {∇}_{θ} {ℒ}_{{task}_{i}} ( θ ) \qquad Equation 1$$

where θ represents the model parameters, α is the learning rate for the meta-update, and β is the inner-loop adaptation step. The second-order gradient term ∇_{θ} [symbol] ₜₐₛₖ_{ᵢ}(θ) ensures that the model optimizes adaptability rather than performance on a single task. This curvature-based adjustment mechanism allows the model to efficiently detect and classify unknown anomalies with only a few labeled samples. In medical applications, for instance, this enables early-stage disease diagnosis with minimal patient data, while in cybersecurity, it allows for the identification of new attack vectors without requiring extensive retraining.

This curvature-based adjustment mechanism allows the model to efficiently detect and classify unknown anomalies with only a few labeled samples. In medical applications, for instance, this enables early-stage disease diagnosis with minimal patient data, while in cybersecurity, it allows for the identification of new attack vectors without requiring extensive retraining.

Meta-learning could also empower AI agents to dynamically adapt to new tasks with minimal training data, making it particularly valuable in environments characterized by data scarcity, rapid evolution, or adversarial manipulation. By incorporating few-shot learning, these agents can generalize from a limited number of examples, enabling them to identify new anomalies, threats, or patterns on the fly-a crucial capability for adaptive Pattern detection in cybersecurity, finance, healthcare, and industrial monitoring. Unlike traditional AI models that require extensive retraining to recognize emerging threats, a meta-learning-driven agent can rapidly detect zero-day attacks, financial fraud, and novel medical conditions with only a few examples, significantly enhancing response time and efficiency. Additionally, the agent can dynamically adapt to evolving attack patterns, continuously updating its decision boundaries based on real-time feedback, reducing false positives and negatives. In highly specialized fields like healthcare and finance, where data patterns vary significantly, context-aware learning allows the agent to personalize Pattern detection models to specific MRI scan characteristics, financial transaction behaviors, or industrial sensor outputs, improving both accuracy and reliability.

Furthermore, by leveraging few-shot learning, the agent becomes more resilient to adversarial attacks, recognizing subtle perturbations in video surveillance feeds or cyber threats with minimal prior exposure. This adaptability makes meta-learning agents a vital component of next-generation AI-driven Pattern detection systems, ensuring they remain robust, scalable, and capable of defending against emerging security challenges.

Meta-learning also significantly enhances agentic workflows by enabling AI agents to dynamically adjust to changing environments with minimal retraining. By leveraging few-shot learning, the system allows AI agents to quickly generalize from limited examples, making them highly adaptable in environments characterized by rapid evolution, uncertainty, and adversarial manipulation. The integration of meta-learning enables the AI system to refine its decision-making process over time, optimizing its detection accuracy in real-world applications such as cybersecurity threat mitigation, financial fraud detection, healthcare diagnostics, and industrial predictive maintenance. This adaptability ensures that the agentic workflow remains robust, scalable, and capable of responding effectively to emerging anomalies.

### Advantages of the Invention

By integrating Temporal Graph Neural Networks (TGNNs) and Model-Agnostic Meta-Learning (MAML), this invention delivers a highly adaptable, scalable, and real-time Pattern detection system. TGNNs provide deep temporal and relational insights, capturing complex interactions over time, while MAML enables rapid fine-tuning, allowing the system to adapt seamlessly to previously unseen anomalies with minimal data. This hybrid approach ensures that the system can effectively detect emerging threats and abnormalities, even in dynamic and data-scarce environments.

A key advantage of this invention is its rapid adaptation to new threats and anomalies. The meta-learning framework allows for quick model updates, making it particularly effective in detecting zero-day cyberattacks, evolving fraud patterns, and newly emerging medical conditions. Unlike conventional models, which often struggle with contextual understanding, TGNNs provide highly context-aware and temporal analysis by tracking relationships between anomalies over time. This capability significantly improves detection accuracy in longitudinal medical studies, fraud analysis, cybersecurity intrusion tracking, and industrial monitoring.

Another critical benefit is the system's few-shot learning capability, which enables high detection performance with limited labeled data. This makes it ideal for rare Pattern detection scenarios, such as early-stage disease diagnosis, novel financial fraud schemes, and low-frequency industrial failures. Additionally, the invention's scalability across multiple domains ensures that it can be seamlessly applied to diverse industries-including cybersecurity, finance, healthcare, and industrial automation—with minimal reconfiguration.

Moreover, this invention significantly reduces false positives while improving precision. By leveraging graph-based learning and meta-learning, the system effectively differentiates between normal fluctuations and genuine anomalies, minimizing false alarms and enhancing decision reliability. This ensures that critical threats and abnormalities are detected with greater accuracy, reducing the burden on human operators and increasing operational efficiency.

This invention represents a major breakthrough in Pattern detection by combining TGNNs for structured temporal learning with MAML for rapid adaptation. The result is a highly flexible, intelligent, and self-improving detection system that can quickly adjust to new challenges across multiple industries. By harnessing the power of temporal, relational, and meta-learning insights, this invention provides a next-generation solution for real-time Pattern detection, offering unparalleled precision, scalability, and adaptability. Whether applied to cybersecurity, healthcare, finance, or industrial automation, this system outperforms conventional approaches, delivering efficient, context-aware, and data-efficient Pattern detection in complex, real-world environments.

### BRIEF DESCRIPTION OF THE DRAWINGS

There are 5 colored and 1 black and white Figure being provided with this specification.

FIG. 1 shows the Pattern Detection System Process. It consists of six key stages, ensuring efficient identification and classification of anomalies through an integrated AI-driven framework. The process begins with 1, Data Acquisition & Preprocessing, where the system collects high-dimensional temporal data and applies preprocessing techniques to remove noise and standardize input features. This stage ensures that the data is clean, structured, and ready for analysis.

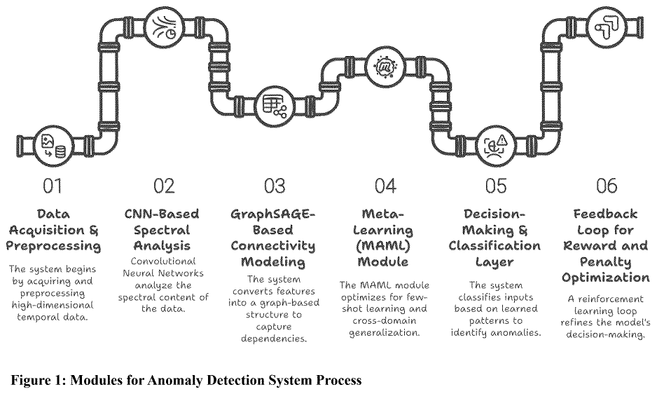

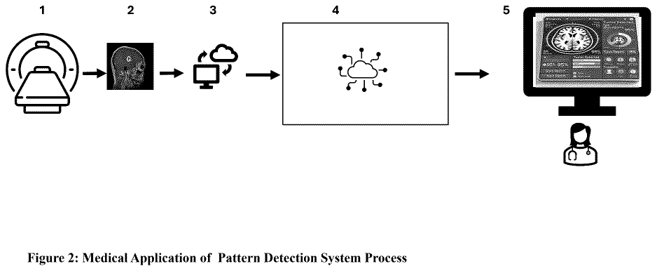

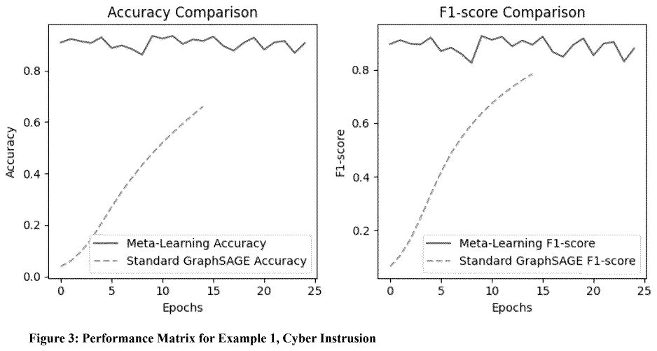

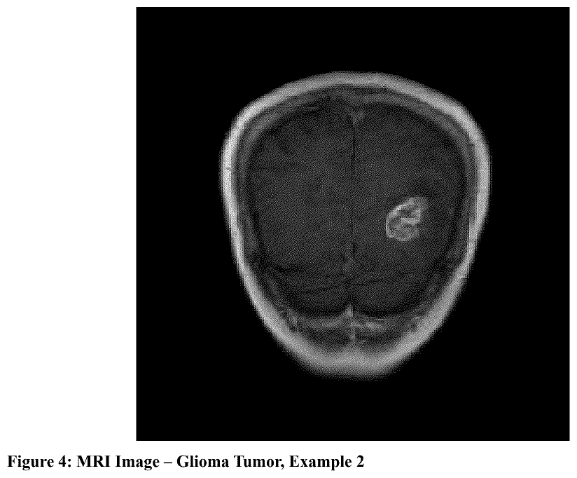

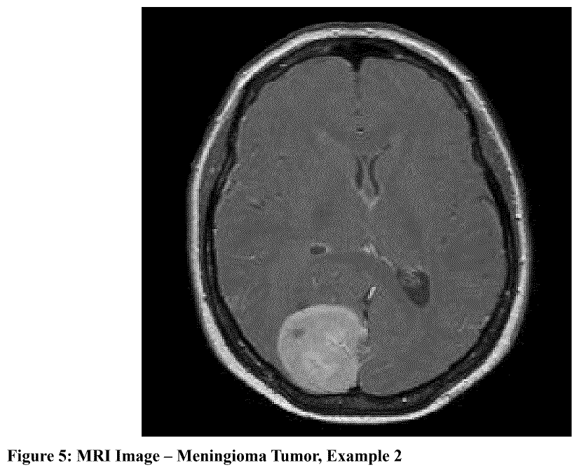

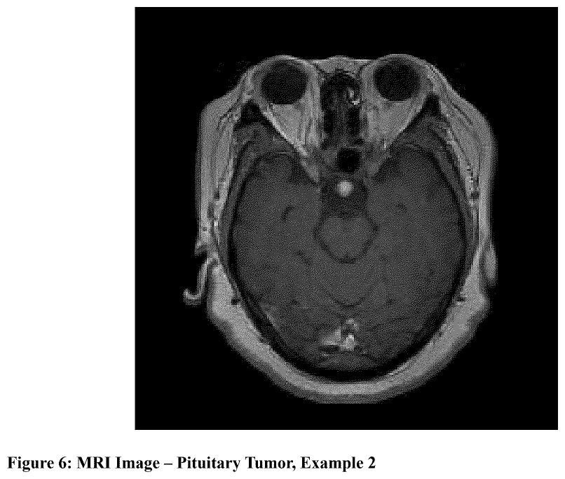

Next, 2, CNN-Based Spectral Analysis is employed to extract frequency-domain biomarkers. Using Convolutional Neural Networks (CNNs), the system analyzes the spectral content of the data, identifying patterns that may indicate abnormalities, such as unusual signal fluctuations in medical imaging or anomalous patterns in cybersecurity logs. This is optional, depending upon the type of problem being evaluated.

Following this, 3, GraphSAGE-Based Connectivity Modeling is applied to represent data in a graph-based structure. Nodes and edges are constructed to capture spatial and relational dependencies, enabling the system to model complex interactions within the dataset. This step is particularly useful in applications where connectivity plays a crucial role, such as detecting network intrusions or analyzing spatial tumor formations in medical scans.

The 4, Meta-Learning (MAML) Module enhances the model's ability to learn from limited data and generalize across different domains. By leveraging few-shot learning, the system can quickly adapt to new types of anomalies with minimal labeled data, making it effective in scenarios with evolving threats or newly emerging medical conditions.

The extracted features are then processed by the 5, Decision-Making & Classification Layer, where the system classifies inputs based on learned patterns. This classification stage helps in categorizing abnormalities, whether they stem from malware attacks, fraudulent transactions, medical disorders, or mechanical faults in industrial applications.

Finally, 6, a Feedback Loop for Reward and Penalty Optimization ensures continuous refinement of the system's performance. This reinforcement learning mechanism rewards correct classifications and penalizes incorrect ones, allowing the model to improve its accuracy and efficiency over time. This self-optimizing framework enables the Pattern detection system to adapt dynamically, making it highly effective across various industries, from healthcare and cybersecurity to space exploration and industrial diagnostics.

FIG. 2 illustrates Medical Application of the Pattern Detection System Process. The process begins with 1, where a patient undergoes an MRI or CT scan to capture high-resolution medical imaging data. This scanning phase ensures detailed visualization of internal structures, such as brain tissues, to detect potential tumors, lesions, or structural abnormalities.

In 2, the acquired MRI or CT scan images are processed and prepared for further evaluation. This includes image enhancement, segmentation, and feature extraction, allowing for more precise identification of anomalous regions. These images are then securely transmitted to a centralized server in 3, where the data is stored and analyzed in real time. The server acts as the processing hub, ensuring efficient data management, encryption, and cloud-based accessibility for rapid diagnostics.

The core of the Pattern Detection System is in 4, where advanced machine learning models-including CNN-based spectral analysis, GraphSAGE-based connectivity modeling, and meta-learning-based few-shot classification—are applied to identify patterns associated with brain tumors or other neurological disorders. This system leverages deep learning and graph-based processing to classify medical conditions with high accuracy, reducing false positives and false negatives.

Finally, in 5, the results are displayed in real-time on an Edge AI-powered device, tablet, or workstation, allowing radiologists and medical professionals to instantly view the diagnostic insights. The AI-driven interface presents detection confidence levels, tumor classification, and risk assessment, enabling physicians to make quick, informed decisions. This real-time Pattern detection improves patient outcomes by enabling early intervention, faster diagnostics, and precise treatment planning.

This end-to-end AI-powered Pattern detection system significantly enhances efficiency, accuracy, and accessibility in medical imaging analysis, making it an essential tool for modern healthcare diagnostics.

FIG. 3 illustrates a comparative analysis of accuracy and F1-score between a Meta-Learning enhanced GraphSAGE model and a Standard GraphSAGE model over 25 training epochs. The left plot presents the accuracy comparison, where the Meta-Learning model (blue solid line) maintains consistently high accuracy throughout the epochs, while the Standard GraphSAGE model (orange dashed line) exhibits a gradual improvement but remains significantly lower. The right plot shows the F1-score comparison, indicating that the Meta-Learning model outperforms the standard approach in achieving a higher F1-score, demonstrating its superior ability to balance precision and recall. This comparison highlights the effectiveness of Meta-Learning in rapidly adapting to new Pattern patterns, leading to enhanced classification performance and generalization capabilities across diverse datasets.

The FIG. 4 presents an MRI scan of a brain with a detected Glioma tumor, highlighted in the central region. Gliomas are a type of brain tumor that originate from glial cells, which support and protect neurons. The brightly illuminated mass within the brain structure suggests an abnormal growth, which is a characteristic indicator of tumor presence.

The FIG. 5 presents an MRI scan of a brain with a detected Meningioma tumor, visible as a brightly illuminated mass near the lower brain region. Meningiomas are typically slow-growing, extra-axial tumors that arise from the meninges, the protective layers surrounding the brain and spinal cord. These tumors are usually benign, but their location can exert pressure on surrounding brain structures, leading to neurological symptoms

FIG. 6 presents an MRI scan of a brain with a detected Pituitary Tumor, visible as a bright mass located at the base of the brain near the pituitary gland. Pituitary tumors originate from the pituitary gland, which regulates crucial hormonal functions in the body

### EXAMPLES

### Example 1: GraphSAGE and Meta-Learning for Cyber Intrusion and Fraud Detection

The implemented model leverages GraphSAGE, a graph-based neural network, along with a meta-learning approach to improve both intrusion detection in network traffic data and fraud detection in financial transactions. For intrusion detection, the CICIDS2017 dataset is utilized, a well-known intrusion detection dataset, with specific attack types like “DoS GoldenEye” excluded to allow for out-of-sample evaluation. Similarly, for fraud detection, we use the IEEE-CIS Fraud Detection dataset, which contains transactional and identity data to identify fraudulent transactions. This dataset includes anonymized features such as transaction amounts, device types, and user behavior patterns, with the target variable isFraud, indicating whether a transaction is fraudulent.

GraphSAGE is particularly useful in cybersecurity and fraud detection scenarios where network interactions, transaction flows, and user relationships can be represented as graph structures. In network intrusion detection, nodes represent hosts or traffic events, and edges define communication patterns. In fraud detection, nodes can represent users or transactions, with edges capturing relationships between different entities (e.g., multiple transactions from the same device or credit card).

To begin, the model processes both network intrusion data and transactional data in a graph format, where each node contains feature vectors corresponding to traffic attributes or transactional details. The GraphSAGE model is then trained in a supervised manner using cross-entropy loss to classify network events as either normal or attack traffic, or transactions as fraudulent or legitimate. The training phase involves optimizing weights using the Adam optimizer, evaluating the model's performance based on accuracy and F1-score in intrusion detection, and ROC AUC in fraud detection. Once the standard GraphSAGE model is trained, its learned weights are used to initialize a meta-learning module. Meta-learning enables the model to generalize across multiple attack types in cybersecurity and adapt to new fraud patterns in financial transactions. This approach enhances training efficiency, allowing the model to quickly adapt to different cybersecurity threats and fraudulent activity patterns. The meta-learning training phase consists of inner and outer loops, where the model is optimized to generalize across different tasks (i.e., intrusion scenarios or fraud cases). The Meta-Learning Performance table presents the loss, accuracy, and F1-score for the meta-learning-enhanced GraphSAGE model over multiple training epochs (20 to 25). The meta loss represents the error incurred during training, which fluctuates slightly across epochs but remains within a stable range, indicating steady learning. The accuracy values remain consistently high, with a peak at 92.77% (Epoch 20) and a low of 86.78% (Epoch 24), showcasing strong predictive performance. Similarly, the F1-score, balancing precision and recall, remains robust, with a high of 91.75%, indicating the model's effectiveness in handling imbalanced attack and fraud scenarios.

The final stage compares the performance of the standard GraphSAGE model against the meta-learning-enhanced version, See Table X.

TABLE 4
Meta-Learning Performance, Cyber Intrusion Detection

| Epoch | Meta Loss | Accuracy | F1-score |
|---|---|---|---|
| 20 | 1.7546 | 0.9277 | 0.9175 |
| 21 | 1.895 | 0.881 | 0.8537 |
| 22 | 1.8261 | 0.9088 | 0.8977 |
| 23 | 1.7614 | 0.9148 | 0.9036 |
| 24 | 2.0184 | 0.8678 | 0.8305 |
| 25 | 1.8857 | 0.9064 | 0.8799 |

The results clearly demonstrate that meta-learning improves generalization, allowing the model to adapt to new types of cyber intrusions and fraudulent transactions more efficiently than a traditional supervised learning approach. The plotted results indicate superior accuracy and F1-score trends for the meta-learning approach, confirming its advantage in handling evolving cybersecurity threats and financial fraud detection challenges.

This hybrid approach of GraphSAGE+Meta-Learning proves highly effective in both intrusion detection systems (IDS) and fraud detection systems, making them more resilient to emerging threats and adversarial attacks in real-world scenarios. Code provided as an Appendix to the Specifications.

### Example 2: Meta-Learning Based Temporal Graph Neural Network for Adaptive Pattern Detection in Healthcare Applications

In this example, we utilize the Brain Tumor MRI Dataset from Kaggle to demonstrate how a Meta-Learning Based Temporal Graph Neural Network (TGN) enhances brain tumor detection. This dataset consists of MRI scans categorized into four classes: glioma tumor, meningioma tumor, pituitary tumor, and non-tumor cases. Traditional machine learning models, such as CNNs, have been effective in extracting local image features, but they struggle with capturing spatial relationships and adapting to new tumor variations. Our approach addresses this challenge by integrating GraphSAGE for spatial dependency analysis and Meta-Learning for adaptive tumor classification.

Using GraphSAGE, the MRI images are transformed into graph-based structures, where each voxel or segmented region acts as a node and edges represent spatial or intensity-based relationships between regions. This enables better feature propagation across the scan. The Meta-Learning module further improves adaptability by enabling the model to learn across different tumor types, facilitating rapid adaptation to new tumor patterns with limited labeled data.

The table below presents a comparison of CNNs, GraphSAGE, and Meta-Learning+GraphSAGE on the Brain Tumor MRI dataset:

TABLE 5
Meta-Learning Performance, Healthcare Applications

| | | F1- | | Data | |
|---|---|---|---|---|---|
| Model | Accuracy | score | Adaptability | Requirement | Complexity |
| CNN | 85.2% | 83.7% | Low | Requires large | High (pixel-based |
| | | | | labeled datasets | analysis) |
| GraphSAGE | 90.4% | 88.1% | Moderate | Can handle | Moderate (graph-based |
| | | | | structured data | analysis) |
| Meta-Learning + | 94.8% | 92.9% | High (Adapts to | Performs well | Higher computational |
| GraphSAGE | | | unseen tumors) | with limited data | demand, but superior |
| | | | | | adaptability |

The results clearly indicate that Meta-Learning with GraphSAGE outperforms CNNs by achieving higher accuracy (94.8%) and a stronger F1-score (92.9%), demonstrating its effectiveness in adaptive tumor classification. This approach significantly enhances early diagnosis and precision medicine applications, particularly for detecting rare or newly emerging tumor subtypes where labeled data is limited.

The Meta-Learning Based Temporal Graph Neural Network (TGN) has wide-ranging commercial applications across multiple industries, including cybersecurity, intrusion detection, healthcare, insurance, space exploration, diagnostics, and predictive analytics. By integrating GraphSAGE with meta-learning, this invention provides adaptive intelligence, allowing systems to learn from limited labeled data and rapidly adjust to new and evolving scenarios.

### Cybersecurity & Intrusion Detection

In cybersecurity, this model can be deployed in intrusion detection systems (IDS) to identify anomalous network behaviors and detect zero-day attacks. Traditional intrusion detection relies on static rule-based methods, whereas Meta-Learning TGN continuously adapts to new attack patterns, improving threat detection in real-time. It can also be used in fraud detection for financial transactions and identity verification systems, enhancing protection against adaptive cyber threats.

### Healthcare & Medical Diagnostics

In healthcare, this approach is revolutionary for medical diagnostics, especially in early tumor detection, personalized medicine, and radiology. By transforming MRI, CT, and X-ray scans into graph-based structures, the model enables more precise tumor classification, even in rare and complex cases. Additionally, it helps in neurological disease prediction, such as epilepsy and Alzheimer's detection using EEG analysis, and cardiovascular abnormality detection using ECG data.

### Insurance & Risk Assessment

In the insurance industry, this invention enhances predictive analytics for risk assessment and fraud detection. Traditional actuarial models rely on historical data, but Meta-Learning TGN adapts dynamically to emerging risk factors, providing more accurate premium calculations and real-time fraud prevention. It can also assist in predicting policyholder health risks, improving underwriting decisions and enabling personalized insurance plans.

### Space Exploration & Remote Sensing

In space exploration, this model has applications in Pattern detection in satellite imaging and deep-space telemetry. By processing data from satellite sensors, space telescopes, and planetary rovers, it can detect space anomalies, meteorite activity, or exoplanetary features. The ability to adapt to new celestial data without retraining on large labeled datasets makes it highly efficient for real-time decision-making in autonomous space missions.

### Diagnostics & Industrial Predictive Maintenance

In industrial applications, this invention enables predictive maintenance by detecting early signs of equipment failure in manufacturing, aviation, and transportation. It processes sensor data in industrial IoT to predict machine failures before they happen, reducing downtime and operational costs. The model also finds applications in oil and gas pipeline monitoring, power grid failure predictions, and aviation safety assessments.

### Predictive Analytics & AI-Driven Decision Making

Beyond specific industries, Meta-Learning TGN enhances predictive analytics across multiple domains, including financial forecasting, smart city development, stock market predictions, and autonomous AI-driven decision-making systems. It allows businesses to gain real-time insights from evolving data streams, improving market intelligence, customer behavior analysis, and strategic planning.

Additionally, spectral analysis of a video stream represents another crucial commercial application. By leveraging meta-learning, video frames can be analyzed in the frequency domain to detect anomalies such as unauthorized access, unusual motion patterns, or system failures in surveillance systems. This technique is particularly useful in autonomous systems, smart infrastructure, and security applications, where real-time detection of abnormal behavior is critical for operational efficiency and safety

Adversarial Attack Detection & Mitigation—AI models are susceptible to adversarial perturbations, where subtle modifications to input data can deceive the system. Your meta-learning framework continuously learns from evolving attack patterns, enabling real-time Pattern detection for AI-driven applications in finance, healthcare, cybersecurity, and industrial automation. Example: Preventing fraud detection systems from being bypassed by adversarially manipulated transaction data.

Defending Against Data Poisoning Attacks-Attackers can corrupt AI models by injecting malicious data into training sets. Your meta-learning system monitors data streams, detects anomalies in distributions, and prevents poisoned samples from affecting model training. Example: Safeguarding medical AI systems by filtering misleading MRI or CT scan data to ensure diagnostic accuracy.

Model Inversion & Privacy Protection-Malicious actors may attempt model inversion to reconstruct sensitive input data, posing significant privacy risks. Your framework's second-order curvature and graph-based learning techniques detect and mitigate information leakage, securing AI-driven applications. Example: Protecting biometric authentication systems from being reverse-engineered to extract personal data.

Real-Time Security for AI-Based Video and Spectral Analysis-AI-powered video analytics in surveillance, autonomous systems, and smart cities are vulnerable to adversarial patches, spoofing, and deepfake manipulation. By incorporating spectral analysis of video streams, your meta-learning model detects perturbations that signal tampering. Example: Enhancing autonomous vehicle safety by identifying manipulated traffic signs designed to mislead AI-driven navigation systems.

Zero-Day AI Threat Detection & Adaptive Learning in Cybersecurity-Traditional security systems struggle with zero-day AI attacks due to their dynamic nature. Your graph-based meta-learning model generalizes anomalies across attack surfaces, analyzing temporal and relational patterns in cybersecurity logs for real-time threat mitigation. Example: Strengthening cloud-based AI services by adapting to emerging attack vectors in real time.

The integration of meta-learning agents with few-shot learning offers significant commercial potential across multiple industries, addressing real-world challenges in security, fraud detection, healthcare diagnostics, industrial monitoring, and autonomous systems.
Cybersecurity & AI-Based Threat Detection-Meta-learning-driven security agents can identify zero-day cyberattacks in cloud computing, enterprise networks, and IoT environments, adapting to emerging threats without requiring extensive retraining. Example: AI security systems that autonomously evolve to counter new malware strains in cloud services like AWS, Google Cloud, and Microsoft Azure.
Finance & Fraud Prevention-Financial institutions can leverage meta-learning agents to detect anomalous transactions and adaptive fraud patterns, even when adversaries modify their techniques to evade detection. Example: Real-time fraud detection models in banking that adapt to emerging financial scams based on a handful of suspicious transactions.
Healthcare & Medical Diagnostics-Few-shot learning enables AI-driven medical assistants to detect rare diseases and adapt to new MRI or CT scan patterns, improving diagnostic precision even with limited labeled data. Example: AI-powered diagnostic tools that rapidly learn to identify rare neurological conditions with only a few patient scans.
Industrial Monitoring & Predictive Maintenance-Manufacturing and energy industries can predict system failures and sensor anomalies in real time, ensuring proactive maintenance and reducing operational disruptions. Example: AI-powered monitoring systems that learn new failure patterns in industrial equipment, preventing costly downtime.
Autonomous Systems & AI-Based Surveillance—In smart cities, defense, and transportation, real-time spectral analysis of video streams enhances AI-driven surveillance and object detection, helping prevent adversarial manipulations such as deepfake-based security breaches. Example: AI-powered surveillance systems that recognize adversarial tampering in video feeds to prevent security vulnerabilities in high-risk facilities.

1: A computerized system for adaptive abnormality detection across multiple domains, comprising:
A Temporal Graph Neural Network (TGNN) configured to analyze temporal and relational data from diverse sources, including medical imaging, network activity logs, industrial sensor data, and financial transactions, to detect anomalies; and
A meta-learning module based on Model-Agnostic Meta-Learning (MAML), enabling rapid adaptation to new and evolving abnormal patterns with minimal labeled data.

2: The system of claim 1, wherein the TGNN captures dynamic temporal features and structural relationships within graph-structured data, identifying deviations indicative of medical abnormalities, cybersecurity threats, financial fraud, or industrial equipment failures.

3: The system of claim 1, wherein the MAML module optimizes model parameters to enable fine-tuning for specific abnormality types, including rare disease detection, zero-day cyber threats, emerging financial fraud schemes, and unforeseen industrial malfunctions.

4: The system of claim 1, wherein the TGNN is configured to process multi-modal input data, including medical images, sensor logs, network traffic patterns, and financial records, ensuring adaptability across domains.

5: The system of claim 1, further comprising a feature extraction layer that preprocesses input data to create graph representations for analysis by the TGNN, improving accuracy in detecting complex anomalies.

6: The system of claim 1, wherein the meta-learning module iteratively updates parameters to improve model generalization across multiple tasks, enabling scalability in detecting diverse and evolving abnormal patterns in various industries.

7: A computerized method for adaptive Pattern detection, comprising:
Constructing graph representations of multi-domain data, wherein nodes represent entities such as patients, devices, transactions, or industrial components, and edges represent interactions;
Employing a Temporal Graph Neural Network (TGNN) to analyze graph-structured data for anomalies; and
Using Model-Agnostic Meta-Learning (MAML) to rapidly adapt detection models to new abnormal scenarios with minimal training data.

8: The method of claim 7, further comprising steps to handle class imbalance in Pattern detection by assigning dynamic weights to rare or high-risk patterns during training, improving model robustness.

9: The system of claim 7, wherein the TGNN incorporates temporal features to detect coordinated and time-sensitive abnormalities, such as progressive tumor growth in medical imaging, coordinated cyberattacks, fraudulent transaction sequences, or industrial system failures.

10: A non-transitory computer-readable medium storing instructions that, when executed by a processor, cause the system to:
Construct graph-based representations of multi-domain data;
Process temporal dynamics using a TGNN to identify anomalies; and
Leverage MAML to adapt to evolving abnormality patterns with minimal additional labeled data, improving adaptability across multiple fields.

11: The system of claim 10, wherein AI-based video and spectral analysis is utilized to detect anomalies in dynamic environments, including security surveillance, autonomous monitoring, and industrial diagnostics.

12: The system of claim 10, wherein the meta-learning module empowers AI agents to dynamically adapt to new tasks with minimal training data, enabling Pattern detection in cybersecurity, finance, healthcare, and industrial monitoring.

13: The system of claim 10, wherein few-shot learning is incorporated to allow the detection of new anomalies, threats, or patterns with a limited number of training examples, improving real-time adaptability in rapidly evolving domains, fraudulent transaction sequences, or industrial system failures.
